(19) United States
(12) Patent Application Publication
(10) Pub. No.: US 2006/0115555 A1
(43) Pub. Date: Jun. 1, 2006

(54) Nutritional supplements containing xanthone extracts

(76) Inventors: Sidney W. Foulger, Potomac, MD (US); Yue Xuan Wu, Rockville, MD (US)

Correspondence Address: ALAN J. HOWARTH, P.O. BOX 1909, SANDY, UT, 84091-1909, US

(21) Appl. No.: 11/001,650

(22) Filed: Dec. 1, 2004

(51) Int. Cl. A23L 1/30

(52) U.S. Cl. 426/72

(57) ABSTRACT

A nutritional supplement composition containing extracted xanthones, vitamins, minerals, carotenoids, flavonoids, and other nutrients is described. The xanthones are extracted from xanthone-rich plants, such as the mangosteen tree, Brazilian malva-do-santo, and a Chinese herb, Swertia davidi.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates to dietary supplements. More particularly, the invention relates to compositions and methods for supplementing the diet for improving health and preventing disease.

Plants have been used worldwide in traditional medicines for the treatment of diseases. It is estimated that even today approximately two-thirds to three-quarters of the world's population rely on medicinal plants as their primary source of medicines. In recent years, the physiological effects of foods (e.g., fruits, vegetables, nuts, and chocolate) and beverages (e.g., fruit juices, wine, tea, and coffee) rich in polyphenolic compounds have generated great interest in the scientific community. As dietary sources of biologically active compounds, these foods prove to be valuable for health. The antioxidant activity exhibited by these plant-derived phenolic compounds and their beneficial effects toward cardiovascular disorders, blood pressure, and high cholesterol have been the primary focus of attention of studies carried out over the past two decades on these compounds.

Oxidative damage to DNA, proteins, and other macromolecules resulting from accumulation of mutagens is considered to be one of the most important causes of degenerative diseases. Studies have shown that free radicals generated by oxidative and other biochemical pathways are important causes of this problem. Free radicals have been implicated in over 50 diseases. It has been estimated that at least 85% of chronic and degenerative diseases result from oxidative damage caused by free radicals. This suggests that free radicals are a fundamental component of tissue injury in many human diseases.

The human body has several mechanisms to counteract damage by free radicals and other reactive oxygen species. One important mechanism that guards against free radical damage is the action of antioxidants, which act as radical scavengers and convert the radicals to less reactive species. The imbalance due to the presence of excessive free radicals and low levels of antioxidants causes oxidative stress and is involved in many chronic health problems, such as cancer; atherosclerosis; myocardial infarction; arthritis; immune diseases such as multiple sclerosis, lupus, and scleroderma; neurodegenerative diseases such as Alzheimer's Disease and Parkinson's Disease; acquired immune deficiency syndrome (AIDS); cataracts; skin wrinkling; and generalized aging. To alleviate this imbalance, there is a general need to improve the quality of food ingested in the human body and to fortify various antioxidative mechanisms in the body.

U.S. Pat. No. 6,730,333 (“Garrity”) describes a nutraceutical beverage containing pericarp (i.e., rind) from the fruit of the mangosteen tree, mangosteen fruit juice, and another fruit or vegetable juice. U.S. Patent Application Publication No. 2004/0146592 also describes a nutraceutical composition containing ground mangosteen fruit (both pericarp and aril) and the juice of a vegetable or fruit other than mangosteen fruit.

While prior art xanthone-containing products and methods of use thereof are known and are generally suitable for their limited purposes, they possess certain inherent deficiencies that detract from their overall utility as nutritional supplements. For example, nutraceuticals made by grinding of mangosteen fruit pulp and/or pericarp and water extraction of xanthones from the ground tissues result in limited release of the xanthones, since xanthones are water insoluble. Mangosteen pericarp, which is contained in some nutraceutical preparations, is digested difficultly or not at all, since the human body does not contain the cellulases or pectinases necessary to digest the celluloses and pectins that largely make up the mangosteen pericarp. Thus, these formulations do not provide xanthones in a readily bioavailable form.

In view of the foregoing, it will be appreciated that providing a nutritional supplement comprising xanthone extracts from xanthone-rich plant parts will provide greater amounts of such xanthones and corresponding greater benefits to consumers.

### BRIEF SUMMARY OF THE INVENTION

It is a feature of the present invention to provide a nutritional supplement that contains xanthone extracts from xanthone-rich plants.

These and other features of the invention can be addressed by providing a nutritional supplement composition comprising a mixture of one or more organic-solvent-extracted xanthones and a nutrient. An illustrative embodiment of one such composition comprises a mixture of one or more organic-solvent-extracted xanthones and one or more vitamins selected from the group consisting of vitamin A, vitamin C, vitamin D, vitamin E, vitamin K, vitamin B-12, thiamine, riboflavin, niacin, pantothenic acid, pyridoxine, folic acid, biotin, derivatives thereof, and mixtures thereof. This nutritional supplement composition can also contain one or more minerals selected from the group consisting of calcium, magnesium, chromium, copper, iodine, iron, manganese molybdenum, selenium, zinc, boron, sodium, potassium, silicon, and mixtures thereof; one or more carotenoids selected from the group consisting of β-carotene, lutein, lycopene, and mixtures thereof; one or more bioflavonoids selected from the group consisting of grape seed extract, quercetin, and mixtures thereof; one or more nutrients selected from the group consisting of choline, para-aminobenzoic acid, alpha-lipoic acid, coenzyme Q10, inositol, methylsulfonyl methane, spirulina, and mixtures thereof; or one or more amino acids selected from the group consisting of arginine, cysteine, glycine, histidine, isoleucine, leucine, methionine, phenylalanine, threonine, tryptophan, valine, and mixtures thereof. The nutritional supplement composition can be in liquid form or in powdered, capsule, or tablet form, or the like.

Another nutritional supplement composition according to the present invention comprises a mixture of one or more organic-solvent-extracted xanthones and one or more minerals selected from the group consisting of calcium, magnesium, chromium, copper, iodine, iron, manganese molybdenum, selenium, zinc, boron, sodium, potassium, silicon, and mixtures thereof.

Still another illustrative embodiment of the invention comprises a nutritional supplement composition comprising a mixture of about 1-200×10⁻³ parts by weight of one or more organic-solvent-extracted xanthones, about 100-3,000×10⁻³ parts by weight of vitamin C, about 10-800 international units of vitamin E, about 500-2,000×10⁻³ parts by weight of calcium, about 1-10×10⁻³ parts by weight of copper, about 1-40×10⁻³ parts by weight of iron, about 1-50×10⁻³ parts by weight of manganese, about 2-100×10⁻³ parts by weight of zinc, about 20-1,000×10⁻⁶ parts by weight of selenium, about 1-200×10⁻³ parts by weight of β-carotene, about 10-1,000×10⁻⁶ parts by weight of lutein, about 10-1,000×10⁻⁶ parts by weight of lycopene, about 5-100×10⁻³ parts by weight of quercetin, about 1-100×10⁻³ parts by weight of grape seed extract, about 1-25×10⁻³ parts by weight of α-lipoic acid, and about 1-100×10⁻³ parts by weight of methionine.

Yet another illustrative embodiment of the invention comprises a nutritional supplement composition comprising a mixture of one or more organic-solvent-extracted xanthones and
(a) one or more vitamins selected from the group consisting of vitamin A, vitamin C, vitamin D, vitamin E, vitamin K, vitamin B-12, thiamine, riboflavin, niacin, pantothenic acid, pyridoxine, folic acid, biotin, derivatives thereof, and mixtures thereof; or

(b) one or more minerals selected from the group consisting of calcium, magnesium, chromium, copper, iodine, iron, manganese molybdenum, selenium, zinc, boron, sodium, potassium, silicon, and mixtures thereof; or

(c) one or more carotenoids selected from the group consisting of β-carotene, lutein, lycopene, and mixtures thereof; or

(d) one or more bioflavonoids selected from the group consisting of grape seed extract, quercetin, and mixtures thereof; or

(e) one or more nutrients selected from the group consisting of choline, para-aminobenzoic acid, alpha-lipoic acid, coenzyme Q10, inositol, methylsulfonyl methane, spirulina, and mixtures thereof; or

(f) one or more amino acids selected from the group consisting of arginine, cysteine, glycine, histidine, isoleucine, leucine, methionine, phenylalanine, threonine, tryptophan, valine, and mixtures thereof.

Another illustrative embodiment of the invention comprises a method for supplementing the diet of an individual, the method comprising orally administering to the individual a nutritional supplement composition comprising a mixture of about 1-200×10⁻³ parts by weight of one or more organic-solvent-extracted xanthones, about 100-3,000×10⁻³ parts by weight of vitamin C, about 10-800 international units of vitamin E, about 500-2,000×10⁻³ parts by weight of calcium, about 1-10×10⁻³ parts by weight of copper, about 140×10⁻³ parts by weight of iron, about 1-50×10⁻³ parts by weight of manganese, about 2-100×10⁻³ parts by weight of zinc, about 20-1,000×10⁻⁶ parts by weight of selenium, about 1-200×10⁻³ parts by weight of β-carotene, about 10-1,000×10⁻⁶ parts by weight of lutein, about 10-1,000×10⁻⁶ parts by weight of lycopene, about 5-100×10⁻³ parts by weight of quercetin, about 1-100×10⁻³ parts by weight of grape seed extract, about 1-25×10⁻³ parts by weight of α-lipoic acid, and about 1-100×10⁻³ parts by weight of methionine.

### DETAILED DESCRIPTION

Before the present nutritional supplements and methods are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to antedate such disclosure by virtue of prior invention.

It must be noted that, as used in this specification and the appended claims, the singular forms “a,” “an,” and “the” include plural referents unless the context clearly dictates otherwise.

Thus, for example, reference to a nutritional supplement composition containing “a xanthone” includes reference to a nutritional supplement composition containing two or more of such xanthones, reference to “an amino acid” includes reference to two or more of such amino acids, and reference to “an antioxidant” includes reference to two or more of such antioxidants.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.” As used herein, “consisting of” and grammatical equivalents thereof exclude any element, step, or ingredient not specified in the claim. As used herein, “consisting essentially of” and grammatical equivalents thereof limit the scope of a claim to the specified materials or steps and those that do not materially affect the basic and novel characteristic or characteristics of the claimed invention.

As used herein, “nutrient” means a substance that, taken into a human or animal, serves to sustain it in its existence, promoting growth, replacing loss, and/or providing energy.

As used herein, “vitamin D” includes all of its active forms including, for example, vitamin D₂ (ergocalciferol), vitamin D₃ (cholecalciferol), and mixtures thereof. Similarly, “vitamin E” includes all of its active forms including, for example, alpha-tocopherol, beta-tocopherol, gamma-tocopherol, delta-tocopherol, and mixtures thereof. Similarly, “vitamin A” includes all of its active forms including, for example vitamin A, (retinol), vitamin A₂ (dehydroretinol), vitamin A acid (retinoic acid), and mixtures thereof. Similarly, “vitamin K” includes all of its active forms including, for example, vitamin K₁ (phylloquinone), vitamin K₂ (farnoquinone), vitamin K₃ (menadione or menaquinone), vitamins K₄₋₇ (synthetic analogs of menadione), and mixtures thereof. Similarly, “vitamin B-12” includes all of its active forms including, for example, cyanocobalamin, methylcobalamin, hydroxocobalamin, nitritocobalamin, and mixtures thereof.

As used herein, “derivatives” of vitamins means alternative, biologically active forms of a particular vitamin. For example, derivatives of vitamin E include esters of vitamin E, such as d-alpha-tocopheryl acetate. As another example, derivatives of vitamin A include esters of vitamin A, such as retinyl palmitate. As still another example, derivatives of niacin include niacinamide. As yet another example, derivatives of pyridoxine include pyridoxal and pyridoxamine. As a still further example, derivatives of vitamins that are acids include salts of such acids, for example, calcium ascorbate, thiamine hydrochloride, pyridoxine hydrochloride, calcium pantothenate, and the like.

As used herein, “effective amount” means an amount of a component of the dietary supplement that is nontoxic but sufficient to provide the desired effect and performance at a reasonable benefit/risk ratio attending any dietary supplement. For example, an effective amount of a vitamin or mineral is an amount sufficient to prevent a deficiency thereof or to reduce the incidence of some cancers, i.e., lung (vitamin E, folic acid, vitamin D, selenium), prostate (vitamin E, vitamin D, selenium), stomach (vitamin C), colorectal (folic acid, vitamin D, selenium), skin (selenium), cervix (folic acid), and breast (vitamin D); osteoporosis (vitamin D, vitamin K, calcium, magnesium, vanadium, and possibly boron and copper); osteoarthritis (calcium); macular degeneration or cataracts (riboflavin, vitamin C, vitamin E, selenium); heart disease (vitamin E, folic acid, pyridoxine, vitamin A, magnesium, selenium, copper); neurologic disease (thiamine, niacin, pantothenic acid, folic acid, vitamin B-12); or Alzheimer's disease (vitamin E), or to aid in regeneration of connective tissue (vitamin C, copper, iron, manganese, zinc). An effective amount of a carotenoid is an amount sufficient to provide a beneficial effect, such as reduce the incidence of some cancers, i.e., skin and mucous membranes (β-carotene), digestive tract (β-carotene, lycopene), prostate and stomach (lycopene), lung (lutein); macular degeneration (lutein); or heart disease (lycopene). An effective amount of a bioflavonoid is an amount sufficient to provide a beneficial effect, such as decrease the incidence of some cancers, i.e., breast, stomach, pancreas, and lung (quercetin); or heart disease (quercetin, grape seed extract). An effective amount of α-lipoic acid is an amount sufficient to provide a beneficial effect, such as reduce the incidence of cataracts or neurologic disease. An effective amount of coenzyme Q10 is an amount sufficient to provide a beneficial effect, such as reduce the incidence of some cancers or heart disease. Such effective amounts can be determined without undue experimentation by those skilled in the art.

Xanthones

This invention relates to xanthone compounds extracted from xanthone-rich medicinal plants, such as Garcinia mangostana (known as the mangosteen plant), Kielmeyera variabilis, and Swertia davidi, and the like. These xanthones are extracted from the plant sources using solvents, and then are combined with other nutrients, such as vitamins, minerals, amino acids, and antioxidants, to serve as a dietary supplement that is beneficial to human or animal health.

Mangosteen is a tree that is fairly widespread in Southeast Asia and is known for its medicinal properties. The fruit hulls have been used in folk medicine for the treatment of skin infections, wounds, and diarrhea in Southeast Asia. Kielmeyera variabilis is a tree commonly known in Brazil as “malva-do-camp” or “pausanto.” It has been used in traditional Brazilian folk medicine for treatment of several tropical diseases, including schistosomiasis, leishmaniasis, malaria, and fungal and bacterial infections. Swertia davidi is a Chinese herb that has been used in treatment of inflammation, allergy, and hepatitis.

Phytochemical studies have shown that these and other plant species are rich in a variety of xanthones, which have demonstrated a number of bioactivities and pharmacological activities. In the last decade, more than 700 scientific papers have been published on the structures, bioactivities, and pharmacological activities of xanthones, and more than 100 different effects have been noted. The bioactivities and pharmacological activities of xanthones include, but are not limited to: antioxidant agents, antifungal and antibacterial, cardiovascular protective agents, antitumor and cancer protective, anti-aging, anti-human immunodeficiency virus (anti-HIV), antilipidemic (blood-fat lowering), hypotensive agent (lowering blood pressure), stimulate immune responses, antidiabetic effects (hypoglycemic; lower blood sugar level), antiobesity, antifatigue, antiathersclerotic (prevents hardening of arteries), antiviral, antidepressant, anti-anxiety, anti-Alzheimererian and anti-Parkinsonism (and other neurodegenerative diseases), antipyretic (lowering fever), antiperiodontic (prevents gum disease), antiallergenic (prevents allergic reactions), antiseborrheic, antiosteoporosis (prevents loss of bone mass), anticalculitic (prevents kidney stones), antidiarrheal, antineuraligic (reduces nerve pain), antiarthritic (prevents arthritis), anticataract (prevents cataracts), antiglaucomic (prevents glaucoma), anti-inflammatory, and anti-ulcer (prevents stomach, mouth, and bowel ulcers) agents.

Xanthones are water insoluble and thus are more readily extracted from plant tissues using organic solvents than aqueous solvents. For example, Nilar & L. J. Harrison, Xanthones from the heartwood of Garcinia mangostana, 60 Phytochemistry 541-548 (2002), describes extraction of xanthones from mangosteen heartwood using hot hexane. The hexane extract was concentrated to yield a crude extract, which was subjected to column chromatography on a silica column using an ethyl acetate-hexane gradient. The resulting fractions were subjected to gel permeation chromatography and high pressure liquid chromatograph (HPLC), which resulted in isolation of numerous xanthones. A. Groweiss et al., HIV-lnhibitory prenylated xanthones and flavones from Maclura tinctoria, 63 J. Nat. Prod. 1537-1539 (2000), describes extraction of xanthones from bark using ethylene chloride-methanol (1:1) as a solvent. C. Gopalakrishnan et al., Anti-inflammatory and C.N.S. depressant activities of xanthones from Calophyllum inophyllum and Mesua ferrea, 12 Ind. J. Pharmac. 181-191 (1980), found that xanthones were freely soluble in n-hexane, benzene, ethanol, and chloroform. C. Ito et al., Cancer chemopreventive agents. New depsidones from Garcinia plants, 64 J. Nat. Prod. 147-150 (2001), described extraction of xanthones from dried leaves using acetone. L. Pinheiro et al., Antibacterial xanthones from Kielmeyera variabilis Mart. (Clusiaceae), 98 Mem. Inst. Oswaldo Cruz 549-552 (2003), describes extraction of xanthones from malva-do-campo with hexane and methanol. D.-J. Jiang et al., Demethylbellidifolin preserves endothelial function by reduction of the endogenous nitric oxide synthase inhibitor level, 93 J. Ethnopharmacology 295-306 (2004), described extraction of xanthones from dried plants using ethanol. Thus, various organic solvents can be used to effectively extract xanthones from plant material.

Illustratively, according to the present invention xanthones were extracted from plants by extraction in hexane-methanol or ethanol. The resulting organic extract was then treated by rotary evaporation to evaporate the solvent, thus resulting in crude xanthones as a water-insoluble gum plus a water-soluble fraction. The water-insoluble gum was then lyophilized, resulting in a xanthone powder.

Extracted xanthones are present in the nutritional supplements according to the present invention in amounts of about 1-200×10⁻³ parts by weight, and typically about 1-100×10⁻³ parts by weight.

Vitamins

Vitamins are organic compounds that are required for the normal growth and maintenance of life of animals, including humans, who are generally unable to synthesize these compounds by anabolic processes that are independent of environment other than air, and which compounds are effective in small amounts, do not furnish energy, and are not utilized as building units for the structure of the organism, but are essential for the transformation of energy and for the regulation of the metabolism of structural units. Vitamins or their precursors are found in plants, and thus plant tissues are the sources for the animal kingdom of these protective nutritional factors. In addition to carbohydrates, fats, proteins, mineral salts, and water, it is essential that the food of humans and animals contain small amounts of these vitamins. If any one of at least 13 of these compounds is lacking in the diet, a breakdown of the normal metabolic processes occurs, which results in a reduced rate or complete lack of growth in children and in symptoms of malnutrition that are classified as deficiency diseases.

The functions of vitamins generally fall into two categories, the maintenance of normal structure and the maintenance of normal metabolic functions. For example, vitamin A is essential for the maintenance of normal epithelial tissue, and vitamin D functions in the absorption of normal bone salts for the formation and growth of a sound bony structure. Certain vitamins, such as thiamine, riboflavin, pantothenic acid, and niacin, are known to be essential constituents of the respiratory enzymes that are required in the utilization of energy from oxidative catabolism of sugars and fats.

It is convenient to divide vitamins into two groups, the water-soluble vitamins and the fat-soluble vitamins. The water-soluble vitamins include ascorbic acid and the B group of vitamins, which comprises some 10 or more well-defined compounds. The fat-soluble vitamins include vitamins A, D, E, and K, since they can be extracted with organic solvents and are found in the fat fractions of animal tissues. For brief reviews of vitamins in general and specific vitamins, see Remington's Pharmaceutical Sciences.

Fat-soluble vitamins. Vitamin A is essential for the maintenance of normal tissue structure and for other important physiologic functions such as vision and reproduction. The source of most of the vitamin A in animals is the carotenoid pigments, i.e. the yellow-colored compounds in all chlorophyll-containing plants. At least 10 different carotenoids exhibit provitamin A activity. For example, α- and β-carotene and cryptoxanthin (found in yellow corn) are important in animal nutrition, β-carotene being the most important. Theoretically, one molecule of β-carotene should yield two molecules of vitamin A. The availability of carotene in foods as sources of vitamin A for humans, however, is low and extremely variable. The conversion of the provitamin to vitamin A occurs primarily in the walls of the small intestine and perhaps to a lesser degree in the liver. Like vitamin A, the carotenes are soluble in organic solvents.

Of the known functions of vitamin A in the body, its role in vision is established best. The retina of man contains two distinct photoreceptor systems. The rods, which are the structural components of one system, are especially sensitive to light of low intensity. A specific vitamin A aldehyde is essential for the formation of rhodopsin, the high molecular weight glycoprotein part of the visual pigment within the rods, and the normal functioning of the retina. By virtue of this relation in the visual process, vitamin A alcohol has been named retinol, and the aldehyde form is named retinal. A vitamin-A deficient person has impaired dark adaptation (“night-blindness”).

Vitamin A also aids in the differentiation of cells of the skin (lining the outside of the body) and mucous membranes (linings inside of the body); helps the body fight off infection and sustain the immune system; and supports growth and remodeling of bone. In addition, dietary vitamin A, in the form of its precursor β-Carotene (an antioxidant), may help reduce risk for certain cancers and other diseases. Vitamin A also assists the sense of taste and aids in the proper functioning of the digestive and urinary tracts. It is also believed to slow aging processes. Further, Vitamin A is important for formation of bones and teeth, storage of fat, and synthesis of protein and glycogen.

Vitamin D is the vitamin effective in promoting calcification of the bony structures of man and animals. It is sometimes known as the “sunshine” vitamin because it is formed by the action of the sun's ultraviolet rays on precursor sterols in the skin. The two immediate biological precursors (provitamins) to Vitamin D are the steroid alcohols, ergosterol (ergosta-5,7,22-trien-3β-ol) and 7-dehydrocholesterol (cholesta-,7-dien-3β-ol). Under the influence of ultraviolet light, each of these provitamins undergoes scission of the 9(10) bond of the steroid nucleus with the simultaneous creation of a 10(19) double bond yielding, respectively, vitamin D₂ (ergocalciferol) and vitamin D₃ (cholecalciferol). Vitamin D aids in the absorption of calcium from the intestinal tract and the resorption of phosphate in the renal tubule. Vitamin D is necessary for normal growth in children, probably having a direct effect on the osteoblast cells, which influence calcification of cartilage in the growing areas of the bone. A deficiency of vitamin D leads to inadequate absorption of calcium from the intestinal tract and retention of phosphorus in the kidney and thus to faulty mineralization of bone structures, including teeth. Vitamin D also maintains a stable nervous system and normal heart action. In recent studies, vitamin D has shown great promise for treating psoriasis and for promoting the immune system, thyroid function, and normal blood clotting.

Vitamin E is a group of compounds (tocol and tocotrienol derivatives) that exhibit qualitatively the biological activity of α-tocopherol. Biological activity associated with the vitamin nature of the group is exhibited by four major compounds: α-, β-, γ-, and δ-tocopherol, each of which can exist in various stereoisomeric forms. The tocopherols act as antioxidants, δ-tocopherol having the greatest antioxidant power. The most critical function of vitamin E occurs in the membranous parts of the cells. Vitamin E interdigitates with phospholipids, cholesterol, and triglycerides, the three main structural elements of the membranes. Since vitamin E is an antioxidant, a favored reaction is with the very reactive and highly destructive compounds called free radicals. Free radicals are products of oxidative deterioration of such substances as polyunsaturated fat. Vitamin E converts the free radical into a less reactive and nonharmful form. This is done by vitamin E giving up one of its electrons to the electron-deficient free radical, which makes the free radical more stable. The antioxidant activity of vitamin E also protects other antioxidants from being oxidized. This antioxidant capability is helpful in preventing degenerative diseases, including heart disease, stroke, arthritis, senility, diabetes, and cancer. Vitamin E also supplies oxygen to the blood, which is then carried to the heart and other organs; thus alleviating fatigue; aids in bringing nourishment to cells; strengthens the capillary walls and prevents the red blood cells from destructive poisons; prevents and dissolves blood clots; and has also been used in helping prevent sterility, muscular dystrophy, calcium deposits in blood walls, and heart conditions. Vitamin E has also been used to reduce or prevent hot flashes in menopause and to increase stamina and endurance. Vitamin E is used topically to great effect for promoting younger looking skin and healing, cutting down the risk of scar formation, and treating eczema, skin ulcers, cold sores, and shingles.

Vitamin K is a group of substances of which the primary activity that makes the vitamin essential in human metabolism is its involvement in the blood-clotting system through synthesis of prothrombin and other clotting factors. The parent structure of the K family of vitamins is 2-methyl-1,4-naphthoquinone. Vitamin K₁, for example, is 2-methyl-3-phytyl-1,4-naphthoquinone (phylloquinone). Vitamin K is necessary for the formation of prothrombinogen and other blood clotting factors in the liver. During clotting, circulating prothrombin is required for the production of thrombin. In turn, thrombin converts fibrinogen to fibrin, the network of which constitutes the clot. It is obvious from this description that interference with formation of prothrombin will reduce the clotting tendency of blood. In a deficiency of the vitamin, a condition of hypoprothrombinemia occurs, and blood-clotting time may be greatly, or even indefinitely, prolonged. Internal or external hemorrhages may ensue either spontaneously or following injury or surgery. Vitamin K is also involved in bone formation and repair. In the intestines, it assists in converting glucose to glycogen, which can then be stored in the liver. There are some indications that vitamin K may decrease the incidence or severity of osteoporosis and slow bone loss.

Water-soluble vitamins. Except for ascorbic acid, all of the vitamins in this category belong the B-group of vitamins. Some still retain their original individual designations, such as B-1, B-6, and B-12, whereas comparable names for other vitamins have become obsolete.

Vitamin C, or ascorbic acid, is known to be essential for the formation of intercellular collagen. Symptoms of scurvy, due to vitamin C deficiency, include bleeding gums, easy bruising, and a tendency toward bone fractures. All these symptoms are a result of the requirement for vitamin C in the development of the ground substance between cells. This ground substance, primarily collagen, is the cement that gives our tissues form and substance. Collagens are principal components of tendons, ligaments, skin, bone, teeth, cartilage, heart valves, intervertebral discs, cornea, and eye lens, in addition to the ground substance between cells. Some collagen forms in the absence of ascorbic acid, but the fibers are abnormal, resulting in skin lesions and blood vessel fragility, characteristics of scurvy. In scorbutic tissues the amorphous ground substance and the fibroblasts in the area between the cells appear normal, but without the matrix of collagen fibers. These bundles of collagenous material appear within a few hours after administration of ascorbic acid. This points to the relationship of the vitamin in maintenance of tooth structures, matrix of bone, and the walls of capillaries. Vitamin C is essential for the healing of bone fractures. Such fractures heal slowly in a patient deficient in vitamin C. This is true also of wound healing.

Vitamin C is also an antioxidant. Oxygen is a highly reactive element, and the process of reacting with certain chemicals is termed oxidation. Oxidation is not always bad. For example, the iron in hemoglobin oxidizes to carry oxygen to all the cells of the body. But much oxidation is damaging, accelerating aging and contributing to tissue and organ damage. Oxidation is also a contributor to heart disease (low density lipoprotein (LDL) oxidation has been linked to atherosclerosis) and cancer. As research continues, the more free-radical damage appears to contribute to chronic conditions and the more antioxidant nutrition supplementation is realized to be is essential. Vitamin C is the most effective water-soluble antioxidant in human plasma. Vitamin C is also a requirement for the proper functioning of the immune system. It is involved in white blood cell production, T-cells, and macrophages. In addition, vitamin C is required in the synthesis of neurotransmitters, steroid hormones, and carnitine, and in the conversion of cholesterol to bile acids and for enhancing iron availability. Vitamin C prevents degenerative diseases, such as cataracts, certain cancers, and cardiovascular diseases. Further, vitamin C promotes healthy cell development, proper calcium absorption, and normal tissue growth and repair, such as in healing of wounds and burns. Still further, vitamin C assists in prevention of blood clotting and bruising, and it strengthens capillary walls. Moreover, it protects against infection and assists in clearing up infections, is thought to enhance the immune system, and aids in reducing cholesterol levels, high blood pressure, and arteriosclerosis.

Biotin functions in synthesis and breakdown of fatty acids and amino acids through aiding the addition and removal of carbon dioxide to or from active compounds. It similarly acts in catalyzing deamination of amino acids and in oleic acid synthesis. It plays a role in the Krebs cycle, which is the process in which energy is released from food, and in maintaining a steady blood sugar level. Biotin is also indicated for healthy hair and skin, sweat glands, nerve tissue, and bone marrow. Biotin is also an essential component of enzymes and aids in the utilization of protein and certain other vitamins, such as folic acid, pantothenic acid, and vitamin B-12.

Folic acid or folacin is one of the important hematopoietic agents necessary for proper regeneration of blood-forming elements and their functioning. That is, folic acid is essential for creating heme, the iron-containing substance in hemoglobin, which is crucial for oxygen transport in the body. Folic acid is also involved as a coenzyme in intermediary metabolic reactions in which one-carbon units are transferred. These reactions are important in interconversions of various amino acids and in purine and pyrimidine synthesis. The biosynthesis of purines and pyrimidines is ultimately linked with that of nucleotides and ribo- and deoxyribo-nucleic acids, functional elements in all cells. Folic acid also assists in digestion, in proper functioning of the nervous system, and improving mental and emotional health. Folic acid may be effective in treating depression and anxiety. Folic acid is also very important in the development of the nervous system and of a developing fetus.

Niacin (nicotinic acid) and niacinamide (nicotinamide) have identical properties as vitamins. In the body niacin is converted to niacinamide, which is an essential constituent of coenzymes I and II that occur in a wide variety of enzyme systems involved in anaerobic oxidation of carbohydrates. The coenzyme serves as a hydrogen acceptor in the oxidation of the substrate. These enzymes are present in all living cells and take part in many reactions of biological oxidation. Nicotinamide-adenine dinucleotide (NAD) and nicotinamide-adenine dinucleotide phosphate (NADP) are coenzymes synthesized in the body that take part in the metabolism of all living cells. Since they are of such widespread and vital importance, it is not difficult to see why serious disturbance of metabolic processes occurs when the supply of niacin or niacinamide to the cell is interrupted. Niacin is readily absorbed from the intestinal tract, and large doses may be given orally or parenterally with equal effect. Further, niacin improves circulation and reduces the cholesterol level in the blood; maintains the nervous system; helps metabolize protein, sugar, and fat; reduces high blood pressure; increases energy through proper utilization of food; prevents the deficiency disease, pellagra; and helps maintain a healthy skin, tongue, and digestive system. This vitamin is used in the synthesis of sex hormones and for treating schizophrenia and other mental illnesses and as a memory enhancer. Niacin, but not niacinamide, given in a drug dosage improves the blood cholesterol profile and has been used to clear the body of organic poisons, such as certain insecticides.

Pantothenic acid is of the highest biological importance because of its incorporation into Coenzyme A (CoA), which is involved in many vital enzymatic reactions transferring a two-carbon compound (the acetyl group) in intermediary metabolism. It is involved in the release of energy from carbohydrate and protein, in the degradation and metabolism of fatty acids, and in the synthesis of such compounds as sterols and steroid hormones, porphyrins, and acetylcholine. Pantothenic acid also participates in the utilization of vitamins; improves the body's resistance to stress; helps in cell building and the development of the central nervous system; helps the adrenal glands, and fights infections by participating in building of antibodies. Pantothenic acid plays an important role in the secretion of hormones, such as cortisone, because of its role in supporting the adrenal gland. These hormones assist in metabolism, help fight allergies, and are beneficial in the maintenance of healthy skin, muscles, and nerves. Pantothenic acid is also used in the release of energy, as well as in the metabolism of fat, proteins, and carbohydrates. It is also used in the synthesis of lipids, neurotransmitters, steroid hormones, and hemoglobin.

Pyridoxine (vitamin B-6) does not denote a single substance, but is rather a collective term for a group of naturally occurring pyridines that are metabolically and functionally interrelated: namely, pyridoxine, pyridoxal, and pyridoxamine. They are interconvertible in vivo in their phosphorylated form. Vitamin B-6 in the form of pyridoxal phosphate or pyridoxamine phosphate functions in carbohydrate, fat, and protein metabolism. Its major functions are most closely related to protein and amino acid metabolism. The vitamin is a part of the molecular configuration of many enzymes (a coenzyme), notably glycogen phosphorylase, various transaminases, decarboxylases, and deaminases. The latter three are essential for the anabolism and catabolism of proteins. Pyridoxine is also aids in fat and carbohydrate metabolism; aids in the formation of antibodies; maintains the central nervous system; aids in the removal of excess fluid of premenstrual women; promotes healthy skin; reduces muscle spasms, leg cramps, hand numbness, nausea and stiffness of hands; and helps maintain a proper balance of sodium and phosphorous in the body. It assists with controlling mood and behavior, and it may be of benefit for children with learning difficulties, as well as in assisting in the prevention of dandruff, eczema, and psoriasis. Pyridoxine assists in the balancing of sodium and potassium, as well as promoting red blood cell production. It is involved in nucleic acid metabolism and is also linked to cancer immunity and fights the formation of homocysteine, which is detrimental to heart muscle.

Riboflavin is another B vitamin (vitamin B-2), which plays its physiological role as the prosthetic group of a number of enzyme systems that are involved in the oxidation of carbohydrates and amino acids. It functions in combination with a specific protein either as a mononucleotide containing phosphoric acid (FMN), or as a dinucleotide combined through phosphoric acid with adenine (FAD). The specificity of each of the enzymes is determined by the protein in the complex. By a process of oxidation-reduction, riboflavin in the system either gains or loses hydrogen. The substrate, either carbohydrate or amino acid, may be oxidized by a removal of hydrogen. The first hydrogen acceptor in the chain of events is NAD or NADP, the di- or tri-nucleotide containing nicotinic acid and adenine. The oxidized riboflavin system then serves as hydrogen acceptor for the coenzyme system and in turn is oxidized by the cytochrome system. The hydrogen is finally passed on to the oxygen to complete the oxidative cycle. A number of flavoprotein enzymes have been identified, each of which is specific for a given substrate. Riboflavin also aids in the formation of antibodies and red blood cells; maintains cell respiration; is necessary for the maintenance of good vision, skin, nails and hair; alleviates eye fatigue; and promotes general health. Riboflavin also is used in red blood cell formation, antibody production, cell respiration, and growth. Further, it is helpful in the prevention and treatment of cataracts, is required for the health of mucus membranes in the digestive tract, and aids absorption of iron and vitamin B-6.

Thiamine or thiamin is a generic term applied to all substances possessing vitamin B-1 activity, regardless of the anion attached to the molecule. The cationic portion of the molecule is made up of a substituted pyrimidine ring connected by a methylene bridge to the nitrogen of a substituted thiazole ring. In a phosphorylated form, thiamine serves as the prosthetic group of enzyme systems that are concerned with the decarboxylation of α-ketoacids. Some decarboxylation reactions are reversible, so that synthesis (condensation) may be achieved. Thus, thiamine is also important to the biosynthesis of keto-acids. It is involved in transketolase reactions. Thiamine is readily absorbed in aqueous solution from both the small and large intestine, and is then carried to the liver by the portal circulation. In the liver, as well as in all living cells, it normally combines with phosphate to form cocarboxylase. It may be stored in the liver in this form, or it may combine further with manganese and specific proteins to become active enzymes known as carboxylases. Thiamine also plays a key role in the body's metabolic cycle for generating energy; aids in the digestion of carbohydrates; is essential for the normal functioning of the nervous system, muscles, and heart; stabilizes the appetite; and promotes growth and good muscle tone. Further, thiamine enhances circulation, and helps with blood formation and metabolism of carbohydrates. It is required for the health of the nervous system and is used in the biosynthesis of a number of cell constituents, including the neurotransmitters, acetylcholine and gamma-aminobutyric acid (GABA). It is also used in the formation of hydrochloric acid and, therefore, plays a part in digestion. It has a beneficial effect on the brain, may help with treating depression, and assists with memory and learning. In children, it is required for growth, and in adults has shown some indication to assist in treating arthritis, cataracts, and infertility.

Vitamin B-12 or cyanocobalamin is essential for the functioning of all cells, but particularly for cells of the bone marrow, the nervous system, and the gastrointestinal tract. It appears to facilitate reduction reactions and participate in the transfer of methyl groups. Its chief importance seems to be, together with folic acid, in the anabolism of DNA in all cells. It is a requisite for normal blood formation, and certain macrocystic anemias respond to its administration. Vitamin B-12 is also necessary for carbohydrate, fat, and protein metabolism; maintains a healthy nervous system; promotes growth in children; increases energy, and is needed for calcium absorption. It also stimulates appetite, promotes growth, and releases energy. It is often used with older people to give an energy boost, assist in preventing mental deterioration, and accelerating thought processes. It is also believed that vitamin B-12 helps clear up infections and protects against allergies and cancer.

The propriety of classifying choline as a vitamin and a member of the B group is questionable because it is synthesized in the human body. Nevertheless, choline plays an important role both as a structural component of tissues and in biological methylation reactions. Dietary deficiency of it leads to gross pathology in several species of animals. Choline is (β-hydroxyethyl)trimethylammonium hydroxide. Since it is completely dissociated in water, it is comparable to alkali hydroxides as a base. Consequently, it does not exist as a base at body pH, but rather as a salt, the anion that is present in its immediate biological environment. The β-(hydroxyethyl)trimethylammonium cation is the biologically important moiety. The cation is incorporated into phospholipids, such as lecithin, sphingomyelin, and acetylcholine, a substance released at cholinergic nerve junctions during transmission of nerve impulses. Besides its vital function as a precursor of acetylcholine, which is important in the sequence of nerve-muscle stimulations, choline is an important contributor of methyl groups needed for the in vivo synthesis of metabolites and perhaps some hormones. The biogenesis of choline appears to be universal in nature, and is the result of the three-step transfer of methyl groups to an acceptor, which may be either free aminoethanol or phosphatidyl aminoethanol. Such transfers require methionine as a methyl donor (actually, S-adenosylmethionine). Choline is indirectly a source of methyl groups; it is first oxidized to betaine, which then may transfer a methyl group to homocysteine to form methionine. By thus regenerating methionine lost in transmethylation reactions, exogenous choline can spare this amino acid for use in protein synthesis. Methionine is an essential amino acid, and thus must be supplied in the diet.

Choline has the property of preventing the deposition of excess fat, or of causing the removal of excess fat from the liver of experimental animals fed high-fat diets and, because of this, is often classified as a “lipotropic agent.” The lipotropic action probably relates to the incorporation of choline into phosphatidyl choline (lecithin), which, in turn, is incorporated into phospholipids and lipoproteins, which are critical for normal membrane structure and function. The lipotropic action is independent of the function of choline as a reservoir of methyl groups.

In the body choline is mainly found in phospholipids, such as lecithin (phosphatidylcholine) and sphingomyelin. The outer leaflet of plasma membrane is rich in these choline-phospholipids whereas the inner leaflet is dominated by phosphatidylethanolamine, phosphatidylserine, and phosphatidylinositol. Phosphatidylcholine, the predominant phospholipid (>50%) in most mammalian membranes, not only contributes to the structure of the membrane bilayer, but products of receptor-mediated lecithin hydrolysis also serve as important second messengers in signal cascades that control cell growth and gene expression. Disaturated phosphatidylcholine is the primary active component of surfactant in the lung; a deficiency of surfactant in the neonate leads to respiratory distress syndrome in premature infants.

The metabolism of choline, methionine, and methyl-folate are closely interrelated; the metabolic pathways intersect at the formation of methionine from homocysteine. Some choline can be formed from methionine (through the methylation of phosphatidylethanolamine by phosphatidylethanolamine N-methyltransferase using S-adenosylmethionine as the methyl donor). This can provide some of the choline required by humans.

Although each of the above functions is absolutely vital for the maintenance of normal cellular and organ functions, it has been difficult to identify choline-deficiency syndromes in humans. The Institute of Medicine noted: “Healthy males with normal folate and vitamin B12 status fed a choline deficient diet have diminished plasma choline and phosphatidylcholine concentrations, and develop liver damage. For these humans, de novo synthesis of choline was not adequate to meet the demand for the nutrient.” Patients fed by total parenteral nutrition sometimes develop fatty liver, abnormal liver function tests, and low plasma choline and phosphatidylcholine concentrations. This is in part due to an impaired capacity to de novo synthesize choline. In some of these patients, these abnormalities resolve when they are treated with a dietary source of choline.

Based on the limited human data that are currently available, the Institute of Medicine, National Academy of Sciences USA, recommended that humans consume choline. It set an adequate intake (AI) level for choline of 550 mg/day for men and 425 mg/day for women. For children, the AI was proportionately adjusted for body size.

Para-aminobenzoic acid (PABA) is often thought of as only an ingredient used in sun screens, while it is actually a nutritional ingredient as well. Since it is a moiety of pteroylglutamic acid (PGA), a form of folic acid, some health professionals do not consider it a vitamin, but only a B-complex factor.

PABA is part of the coenzyme tetrahydrofolic acid. As such, it aids in the utilization of amino acids, supports red blood cell formation, and assists in the manufacture of folic acid in the intestines. It has been linked to hair growth, as well as reversing the graying of hair, but these results are disappointing. People suffering from vitiligo, over-pigmentation of skin, or without pigment in some spots, have reported an improvement of the skin after more PABA was ingested.

When PABA is in short supply, fatigue, irritability, nervousness, constipation, and depression might manifest themselves. Weeping eczema has also been noted in people with PABA deficiency as well as patchy areas on the skin. There is no Recommended Dietary Allowance (RDA) for PABA, but 50 mg per day is usually used in supplementation. Nausea, skin rashes, and vomiting might be indicative of PABA taken in excess. Excessive levels of PABA are stored in the body and may cause liver damage. PABA is best used in combination with vitamin C and the B group vitamins, particularly folic acid. Long term antibiotic use may require more PABA from the body, but PABA affects the effectiveness of sulfa drugs. Although not documented in medical terms, some women having problems becoming pregnant claim to have conceived after increasing PABA in their diets.

Illustrative formulations and ranges of these ingredients are:

| | Ranges in Parts by Weight | |
|---|---|---|
| | or International Units (IU) | |
| Vitamins | Broad | Typical |
| A | 1,000-10,000 IU | 1,000-5,000 IU |
| D | 50-1,000 IU | 100-800 IU |
| E | 10-800 IU | 100-800 IU |
| K | 20-200 × 10⁻⁶ | 20-160 × 10⁻⁶ |
| C | 100-3,000 × 10⁻³ | 500-1,000 × 10⁻³ |
| Thiamine (B-1) | 1-50 × 10⁻³ | 5-30 × 10⁻³ |
| Riboflavin (B-2) | 1-40 × 10⁻³ | 2-20 × 10⁻³ |
| Niacin/Niacinamide (B-3) | 0.5-150 × 10⁻³ | 10-150 × 10⁻³ |
| Pantothenic Acid (B-5) | 1-100 × 10⁻³ | 5-50 × 10⁻⁶ |
| Pyridoxine (B-6) | 1-100 × 10⁻³ | 1-50 × 10⁻³ |
| Folate | 100-3,000 × 10⁻⁶ | 200-2,000 × 10⁻⁶ |
| B-12 | 2-160 × 10⁻⁶ | 10-100× 10⁻⁶ |
| Biotin | 50-5,000 × 10⁻⁶ | 100-1,000 × 10⁻⁶ |
| Choline | 25-600 × 10⁻³ | 50-550 × 10⁻³ |
| PABA | 1-100 × 10⁻³ | 25-100 × 10⁻³ |

Minerals

Minerals serve a wide variety of essential physiological functions ranging from structural components of body tissues to essential components of many enzymes and other biological important molecules. Minerals are classified as micronutrients or trace elements on the basis of the amount present in the body. The seven micronutrients (calcium, potassium, sodium, magnesium, phosphorus, sulphur, and chloride) are present in the body in quantities of more than five grams. Trace elements, which include boron, copper, iron, manganese, selenium, and zinc are found in the body in quantities of less than five grams.

Micronutrient Minerals. Calcium is the mineral element believed to be most deficient in the diet in the United States. Calcium intakes in excess of 300 mg per day are difficult to achieve in the absence of milk and dairy products in the diet. This is far below the recommended dietary allowance (RDA) for calcium (1000 mg per day for adults and children ages one to ten, 1200 mg per day for adolescents and pregnant and lactating women, which equates to about four glasses of milk per day). In fact, it has been reported that the mean daily calcium intake for females over age 12 does not exceed 85 percent of the RDA. In addition, during the years of peak bone mass development (18 to 30), more than 66 percent of all U.S. women fail to consume the recommended amounts of calcium on any given day. After age 35, this percentage increases to over 75 percent.

Although the general public is not fully aware of the consequences of inadequate mineral intake over prolonged periods of time, there is considerable scientific evidence that low calcium intake is one of several contributing factors leading to osteoporosis. In addition, the dietary ratio of calcium to phosphorous (Ca:P) relates directly to bone health. A Ca to P ratio of 1:1 to 2:1 is recommended to enhance bone marrowization in humans. Such ratios are difficult to achieve absent an adequate dietary supply of milk and dairy products, or an adequate supply of calcium and other minerals for the lactose-intolerant segment of the population.

Calcium is needed for formation and maintenance of bones, the development of teeth, and maintaining healthy gums. Calcium is also necessary for blood clotting and stabilizing many body functions, and is thought to assist in preventing bowel cancer.

Magnesium is the second most plentiful cation of the intracellular fluids. It is essential for the activity of many enzyme systems and plays an important role with regard to neurochemical transmission and muscular excitability. Deficits are accompanied by a variety of structural and functional disturbances. The average 70-kg adult has about 2000 mEq of magnesium in the body. About 50% of this magnesium is found in bone, 45% exists as an intracellular cation, and 5% is in the extracellular fluid. About 30% of the magnesium in the skeleton represents an exchangeable pool present either within the hydration shell or on the crystal surface. Mobilization of the cation from this pool in bone is fairly rapid in children, but not in adults. The larger fraction of magnesium in bone is apparently an integral part of bone crystal.

The average adult in the United States ingests about 20 to 40 mEq of magnesium per day in an ordinary diet, and of this about one third is absorbed from the gastrointestinal tract. The evidence suggests that the bulk of the absorption occurs in the upper small bowel. Absorption is by means of an active process apparently closely related to the transport system for calcium. Ingestion of low amounts of magnesium results in increased absorption of calcium and vice versa.

Magnesium is a cofactor of all enzymes involved in phosphate transfer reactions that utilize adenosine triphosphate (ATP) and other nucleotide triphosphates as substrates. Various phosphatases and pyrophosphatases also represent enzymes from an enormous list that are influenced by this metallic ion.

Magnesium plays a vital role in the reversible association of intracellular particles and in the binding of macromolecules to subcellular organelles. For example, the binding of messenger RNA (mRNA) to ribosomes is magnesium dependent, as is the functional integrity of ribosomal subunits. Certain of the effects of magnesium on the nervous system are similar to those of calcium. An increased concentration of magnesium in the extracellular fluid causes depression of the central nervous system (CNS). Hypomagnesemia causes increased CNS irritability, disorientation, and convulsions. Magnesium also has a direct depressant effect on skeletal muscle. Abnormally low concentrations of magnesium in the extracellular fluid result in increased acetylcholine release and increased muscle excitability that can produce tetany. Magnesium helps with formation of teeth and bones and assists the absorption of calcium and potassium. Where calcium stimulates the muscles, magnesium relaxes the muscles. Magnesium is further needed for cellular metabolism and the production of energy through its help with enzyme activity. It is used for muscle tone of the heart and assists in controlling blood pressure. Together with vitamin B-12, magnesium may prevent calcium oxalate kidney stones, depression, dizziness, muscle twitching, and pre-menstrual syndrome (PMS). It can help prevent the calcification of soft tissue and may help prevent cardiovascular disease, osteoporosis, and certain forms of cancer, and it may reduce cholesterol levels.

Sodium is an electrolyte in the body and is required for the manufacture of hydrochloric acid in the stomach, which helps to protect the body from infections.

Potassium is needed for growth, building of muscles, transmission of nerve impulses, heart activity, and other body processes.

While not generally classified as either a micronutrient or a trace element, silicon is important for maintaining health of bones, cartilage, tendons, and artery walls. Silicon may also be beneficial in the treatment of allergies, heartburn, and gum disease, as well as promoting a healthy immune system. Silicon is also required for keeping nails, hair, and skin in good condition and is useful in counteracting the effects of aluminum.

Trace Elements. Boron is required by the body in trace amounts for proper metabolism of calcium, magnesium, and phosphorus, as well as vitamin D. Boron helps brain function, healthy bones, and can increase alertness. Boron is also useful for people who want to build muscle. Boron is known to help prevent postmenopausal osteoporosis. Further, a relationship has been shown between a lack of boron in the diet and the chances of developing arthritis. R. E. Newnham, 46 Journal of Applied Nutrition (1994).

Chromium is an important trace element wherein the lack of sufficient chromium in the diet leads to impairment of glucose utilization, however, disturbances in protein and lipid metabolism have also been observed. Impaired glucose utilization occurs in many middle-aged and elderly human beings. In experimental studies, significant numbers of such persons have shown improvement in their glucose utilization after treatment with chromium. Chromium is transported by transferrin in the plasma and competes with iron for binding sites. Chromium as a dietary supplement may produce benefits due to its enhancement of glucose utilization and its possible facilitating the binding of insulin to insulin receptors, which increases its effects on carbohydrate and lipid metabolism. It functions with glucose tolerance factor (GTF) when this hormone-affiliated enters the bloodstream because of an increase of insulin. Chromium as a supplement may produce benefits in atherosclerosis, diabetes, rheumatism, and weight control.

Copper is another important trace element in the diet. The most common defect observed in copper-deficient animals is anemia. Other abnormalities include growth depression, skeletal defects, demyelination and degeneration of the nervous system, ataxia, defects in pigmentation and structure of hair or wool, reproductive failure, and cardiovascular lesions, including dissecting aneurisms. Several copper-containing metalloproteins have been isolated, including tyrosinase, ascorbic acid oxidase, laccase, cytochrome oxidase, uricase, monoamine oxidase, δ-aminolevulinic acid hydrydase, and dopamine-β-hydroxylase. Copper functions in the absorption and utilization of iron, electron transport, connective tissue metabolism, phospholipid formation, purine metabolism, and development of the nervous system. Ferroxidase I (ceruloplasmin), a copper-containing enzyme, effects the oxidation of Fe(II) to Fe(III), a required step for mobilization of stored iron. A copper-containing enzyme is thought to be responsible for the oxidative deamination of the epsilon amino group of lysine to produce desmosine and isodesmosine, the cross-links of elastin. In copper-deficient animals the arterial elastin is weaker and dissecting aneurisms may occur. Copper is required in the formation of hemoglobin, red blood cells, and bones, while it helps with the formation of elastin and collagen, thus making it necessary for wound healing. Copper is also a constituent of superoxide dismutase (SOD), a powerful enzyme that scavenges free radicals in cells.

Iodine is important for the production of thyroid hormones, which regulate cellular oxidation. The iodine-deficiency disease is goiter. In iodine-deficient young, growth is depressed and sexual development is delayed, the skin and hair are typically rough, and the hair becomes thin. Cretinism, feeble-mindedness, and deaf-mutism occur in a severe deficiency. There is reproductive failure in females and decreased fertility in males that lack sufficient iodine in the diet. Iodine-containing thyroid hormones regulate the conversion of fat to energy, thus stabilizing body weight and controlling cholesterol levels.

Iron is an essential component of several important metalloproteins. These include hemoglobin, myoglobin, and many oxidation-reduction enzymes. In iron deficiency, there may be reduced concentrations of some of the iron-containing enzymes, such as cytochrome c in liver, kidney, and skeletal muscle, and succinic dehydrogenase in the kidney and heart. Thus, iron is needed for oxygenation of red blood cells, a healthy immune system, and energy production. Iron is a component of several peroxidase enzymes and cofactors of these enzymes. Therefore, iron is involved in scavenging of hydrogen peroxide radicals.

Manganese plays a role in the synthesis of glycosaminoglycans (GAGs), collagen, and glycoproteins, which are important constituents of cartilage and bone. Manganese is required for enzyme activity of glycosyltransferases. This family of enzymes is responsible for linking sugars together into GAGs, adding sugars to other glycoproteins, adding sulfate to aminosugars, converting sugars to other modified sugars, and adding sugars to lipids. These functions are manifested as GAG synthesis (hyaluronic acid, chondroitin sulfate, karatan sulfate, heparin sulfate, and dermatin sulfate, among others), collagen synthesis, and function of many other glycoproteins and glycolipids. GAGs and collagen are chief structural elements for all connective tissues. Their synthesis is essential for proper maintenance and repair of connective tissues.

Manganese deficiencies in humans and animals lead to abnormal bone growth, swollen and enlarged joints, and slipped tendons. In humans, manganese deficiencies are associated with bone loss, arthritis, and impaired glucose utilization. Levels of all GAGs are decreased in connective tissues during manganese deficiencies, with chondroitin sulfates being most depleted. Manganese-deficient organisms quickly normalize GAG and collagen synthesis when manganese is provided.

Manganese is also required for activity of manganese superoxide dismutase (MnSOD), which is present only in mitochondria. Manganese deficiency decreases the activity of MnSOD and may lead to mitochondrial dysfunction, manifested as decreased cellular functions. MnSOD is a powerfiil enzyme that scavenges free radicals in mitochondria. It is also believed that MnSOD assists in preventing diabetes and is needed for normal nerve function. Manganese is required for the conversion of mevalonic acid to squalene. Pyruvate carboxylase is a manganese metalloenzyme, which is repressible by insulin and important in the citric acid cycle for the oxidation of carbohydrates, lipids, and proteins, as well as in the synthesis of glucose and lipids. Manganese also enables the body to utilize vitamin C, vitamin B-1, and biotin, as well as choline. Manganese is used in the manufacture of fat, sex hormones, and breast milk. Manganese also is thought to important in brain functioning.

Molybdenum is an essential mineral found in highest concentrations in the liver, kidneys, skin, and bones. This mineral is required by the body to properly metabolize nitrogen. It is also a vital component of the enzyme xanthine oxidase, which is required to convert purines to uric acid, a normal byproduct of metabolism. Molybdenum also supports the body's storage of iron and other cellular functions, such as growth. A deficiency of molybdenum is associated with mouth and gum disorders and cancer. A diet high in refined and processed foods can lead to a deficiency of molybdenum, resulting in anemia, loss of appetite and weight, and stunted growth in animals. While these deficiencies have not been observed directly in humans, it is known that a molybdenum deficiency can lead to impotence in older males. Molybdenum also assists in breaking down sulfite toxin build-up in the body, and may prevent cavities. These qualities suggest that molybdenum possesses antioxidant properties. Further, molybdenum assists the body in fighting nitrosamines, which are associated with certain cancers.

Selenium is an essential trace element that functions as a component of enzymes involved in protection against free radicals and in thyroid hormone metabolism. In several intra- and extra-cellular glutathione peroxidases and iodothyronine 5′-deiodinases, selenium is located at the active centers as the selenoamino acid, selenocysteine (SeCYS). At least two other proteins of unknown function also contain SeCYS. Although SeCYS is an important dietary form, it is not directly incorporated into these specific selenium-proteins; instead, a co-translational process yields tRNA-bound SeCYS. In contrast, selenium as seleno-methionine is incorporated non-specifically into many proteins, as it competes with methionine in general protein synthesis. Therefore, tissues often contain both specific, as well as the nonspecific, selenium-containing proteins when both SeCYS and selenomethionine are consumed, as found in many foods. Selenium is a major antioxidant nutrient and is involved in protecting cell membranes and preventing free radical generation, thereby decreasing the risk of cancer and disease of the heart and blood vessels. Medical surveys show that increased selenium intake decreases the risk of breast, colon, lung, and prostate cancer. Selenium also preserves tissue elasticity; slows down the aging and hardening of tissues through oxidation; and helps in the treatment and prevention of dandruff. Recent research has shown antitumorigenic effects of high levels of selenium in the diets of several animal models. Moreover, selenium helps rid the body of toxic heavy metals, such as mercury, lead, and cadmium. Selenium also stimulates increased antibody response to infections, promotes more energy in the body, alleviates menopausal symptoms in women, and promotes production of healthy sperm in males. In certain cases, selenium has proven effective in fighting cold sores and shingles, both of which are caused by herpes virus.

Zinc is known to occur in many important metalloenzymes. These include carbonic anhydrase, carboxypeptidases A and B, alcohol dehydrogenase, glutamic dehydrogenase, D-glyceraldehyde-3-phosphate dehydrogenase, lactic dehydrogenase, malic dehydrogenase, alkaline phosphatase, and aldolase. Impaired synthesis of nucleic acids and proteins has been observed in zinc deficiency. There is also evidence that zinc may be involved in the secretion of insulin and in the function of the hormone. Zinc is also necessary for a healthy immune system and is useful for treating skin conditions, such as acne and boils, and for treating sore throats. Zinc is also needed for cell division and for growth and maintenance of muscles. Children need zinc in the diet for normal growth and sexual development. Zinc is also a constituent of superoxide dismutase (ZnSOD), which scavenges free radicals. Further, zinc is required for growth and maintenance of hair, nails, and skin.

Illustrative formulations and ranges of these ingredients are:

| | Ranges in Parts by Weight | |
|---|---|---|
| Minerals | Broad | Typical |
| Calcium | 500-2,000 × 10⁻³ | 500-1,500 × 10⁻³ |
| Magnesium | 50-1,000 × 10⁻³ | 100-800 × 10⁻³ |
| Chromium | 10-500 × 10⁻⁶ | 10-300 × 10⁻⁶ |
| Copper | 1-10 × 10⁻³ | 1-5 × 10⁻³ |
| Iodine | 10-500 × 10⁻⁶ | 10-300 × 10⁻⁶ |
| Iron | 1-40 × 10⁻³ | 5-20 × 10⁻³ |
| Manganese | 1-50 × 10⁻³ | 2-25 × 10⁻³ |
| Molybdenum | 5-200 × 10⁻⁶ | 10-100 × 10⁻⁶ |
| Selenium | 20-1,000 × 10⁻⁶ | 20-500 × 10⁻⁶ |
| Zinc | 2-100 × 10⁻³ | 5-40 × 10⁻³ |
| Boron | 100-1,000 × 10⁻⁶ | 200-800 × 10⁻⁶ |
| Sodium | 100-500 × 10⁻³ | 200-400 × 10⁻³ |
| Potassium | 10-500 × 10⁻³ | 100-400 × 10⁻³ |
| Silicon | 1-100 × 10⁻³ | 5-50× 10⁻³ |

According to the present invention, minerals can be provided as inorganic compounds, such as chlorides, sulfates, iodides, and the like. In addition, some minerals can be provided in more bioavailable forms, such as amino acid chelates, which are well known in the art. U.S. Pat. No. 5,292,538. Examples of minerals that can be provided as amino acid chelates include calcium, magnesium, manganese, zinc, iron, boron, copper, molybdenum, chromium, and silicon. Still further, minerals can be provided as organic compounds, such as ascorbates, citrates, picolinates, aspartates, carbonates, bicarbonates, and the like. Illustrative examples of various mineral forms according to the present invention include potassium bicarbonate, sodium bicarbonate, calcium carbonate, calcium ascorbate, zinc picolinate, manganese picolinate, copper aspartate, molybdenum trioxide, chromium picolinate, potassium iodide, boron citrate, silicon amino acid chelate, and the like.

Carotenoids

Carotenoids are a family of hundreds of plant pigments found in fruits and vegetables that are red, orange, and deep yellow in color, and also in some dark green leafy vegetables. See USDA-NCC Carotenoid Database for U.S. Foods (1998). Carotenoids are the precursors of most of the vitamin A found in animals. At least 10 different carotenoids exhibit provitamin A activity, including α- and β-carotenes and cryptoxanthin. As precursors of vitamin A, carotenoids exhibit an effect on vision, but carotenoids are known to have other beneficial effects in the diet, as well. For example, carotenoids are also known for their antioxidant activity in helping protect the body from free radical damage.

Volumes of research reveal that two carotenoids—lutein and zeaxanthin—are found in great concentrations in the macula of the eye. This research also indicates that maintaining high levels of these two carotenoids, especially lutein, may help diminish the effects of age-related macular degeneration, the leading cause of blindness in those over 65 years of age. Lutein acts as an antioxidant, protecting cells against the damaging effects of free radicals. As with the other carotenoids, lutein is not made in the body and, therefore, must be obtained from food or dietary supplements.

At one time researchers believed all antioxidants served the same purpose. Now there is growing evidence that individual antioxidants may be used by the body for specific purposes. Researchers believe that lutein is deposited into areas of the body most prone to free radical damage. One major example is the macula, a tiny portion of the retina. Research indicates that because of its antioxidant properties, lutein consumption may play a role in maintaining the health of the eyes, heart and skin as well as the breasts and cervix in women. In addition, scientists are studying lutein's possible role in age-related macular degeneration, cataracts, heart disease, and immune system health. Studies have also shown that lutein is associated with a reduction in lung, breast, and cervical cancer. In the vascular system, lutein is found in high-density lipoprotein (“HDL”) or “good” cholesterol and may prevent low-density lipoprotein (“LDL”) or “bad” cholesterol from oxidizing, which sets the cascade for heart disease.

Lycopene is an open-chain unsaturated carotenoid that imparts red color to tomatoes, guava, rosehip, watermelon, and pink grapefruit. Lycopene is a proven anti-oxidant that may lower the risk of certain diseases including cancer and heart disease. In the body, lycopene is deposited in the liver, lungs, prostate gland, colon, and skin. Its concentration in body tissues tends to be higher than all other carotenoids. Epidemiological studies have shown that high intake of lycopene-containing vegetables is inversely associated with the incidence of certain types of cancer. For example, habitual intake of tomato products has been found to decrease the risk of cancer of the digestive tract among Italians. In one six-year study by Harvard Medical School and Harvard School of Public Health, the diets of more than 47,000 men were studied. Of 46 fruits and vegetables evaluated, only the tomato products (which contain large quantities of lycopene) showed a measurable relationship to reduce prostate cancer risk. As consumption of tomato products increased, levels of lycopene in the blood increased, and the risk for prostate cancer decreased. Ongoing research suggests that lycopene can reduce the risk of macular degenerative disease, serum lipid oxidation, and cancers of the lung, bladder, cervix and skin. Studies are underway to investigate other potential benefits of lycopene including lycopene's potential in the fight against cancers of the digestive tract, breast, and prostate. W. Stahl & H. Sies, Lycopene: a biologically important carotenoid for humans? 336 Arch. Biochem. Biophys. 1-9 (1996); H. Gerster, The potential role of lycopene for human health, 16 J. Amer. Coll. Nutr. 109-126 (1997).

Illustrative formulations and ranges of these ingredients are:

| | Ranges in Parts by Weight | |
|---|---|---|
| Carotenoids | Broad | Typical |
| β-Carotene | 1-200 × 10⁻³ | 10-100 × 10⁻³ |
| Lutein | 10-1,000 × 10⁻⁴ | 50-500 × 10⁻⁶ |
| Lycopene | 10-1,000 × 10⁻⁶ | 5-500 × 10⁻⁶ |

Flavonoids

Flavonoids (also called bioflavonoids) are natural botanical pigments that provide protection from free-radical damage, among other functions. Bioflavonoids provide protection from damaging free radicals and are believed to reduce the risk of cancer and heart disease, decrease allergy and arthritis symptoms, promote vitamin C activity, improve the strength of blood vessels, block the progression of cataracts and macular degeneration, treat menopausal hot flashes, and other ailments. Flavonoids occur in most fruits and vegetables. It is believed that flavonoids act by inhibiting hormones, such as estrogen, that may trigger hormone-dependent malignancies like cancers of the breast, endometrium, ovary, and prostate. Studies show that quercetin, a flavonoid found in citrus fruits, can block the spread of cancer cells in the stomach. Flavonoids also stabilize mast cells, a type of immune cell that releases inflammatory compounds, like histamine, when facing foreign microorganisms. Histamine and other inflammatory substances are involved in allergic reactions. Mast cells are large cells present in connective tissue. Flavonoids fortify and repair connective tissue by promoting the synthesis of collagen. Collagen is a remarkably strong protein of the connective tissue that “glues” the cells together. Flavonoids are believed to benefit connective tissue and reduce inflammation.

Quercetin is a bioflavonoid and a natural reverse transcriptase blocker commonly found in onions, apples, kale, sweet cherries, grapes, red cabbage, and green beans. Quercetin has been shown to have antiviral activity against HIV, herpes simplex, and the respiratory syncytial virus. T. N. Kaul et al., Antiviral effects of flavonoids on human viruses, 15 J. Med. Virol. 71-79 (1985); R. Vrijsen et al., Antiviral activity of flavones and potentiation by ascorbate, 69 J. Gen. Virol. 1749-1751 (1988). Further, quercetin is useful for treating allergies and preventing heart disease and cancer. As an antioxidant, quercetin combats free radicals, which play a part in many diseases.

Grape seed extract is another source of bioflavonoids. Grape seed extract has been known to exhibit the following benefits: anti-inflammatory, antihistamine, antiallergenic, antioxidant (free radical scavenger), helps skin to remain young looking, improves circulation, promotes healing, restores collagen, strengthens weak blood vessels, and improves tissue elasticity. Some known applications include treatment of arthritis, allergies, hardening of arteries, ulcers, and skin problems.

Illustrative formulations and ranges of these ingredients are:

| | Ranges in Parts by Weight | |
|---|---|---|
| Bioflavonoids | Broad | Typical |
| Grape Seed Extract | 1-100 × 10⁻³ | 2-20 × 10⁻³ |
| Quercetin | 5-100 × 10⁻³ | 10-50 × 10⁻³ |

Other Nutrients Alpha-lipoic acid (technically known as DL-alpha lipoic acid) is a powerful antioxidant being researched for unique properties that may provide both preventive and therapeutic benefits in numerous conditions and diseases including diabetes, heart disease, and possibly even HIV infection. Lipoic acid and its reduced form, DHLA, show the ability to directly quench a variety of reactive oxygen species, inhibit reactive oxygen generators, and spare and regenerate other antioxidants. Lipoic acid not only protects the nervous system, but is also involved in regenerating nerves. It is also being studied in the treatment of Parkinson's disease and Alzheimer's disease. Lipoic acid is best known for its ability to help regenerate damaged liver tissue when nothing else will. Lipoic acid is marketed in Germany for treating diabetic neuropathy. It also has an essential role in mitochondrial dehydrogenase reactions. Lipoic acid prevents and treats many age-related diseases, from heart disease and stroke to diabetes and cataracts.

Coenzyme Q10 is an essential electron and proton carrier that functions in the production of biochemical energy in aerobic organisms. Coenzyme Q10 is found in every cell in the body, thus its other name, ubiquinone (from the word ubiquitous and the coenzyme quinone). The structure of coenzyme Q10 consists of a quinone ring attached to an isoprene side chain. Because the body must have energy available to perform even the simplest operation, coenzyme Q10 is considered essential for the body's cells, tissues, and organs. Coenzyme Q10 also has antioxidant and membrane stabilizing properties that serve to prevent the cellular damage that results from normal metabolic processes. Even though the body has the ability to produce coenzyme Q10, deficiencies have been reported in a range of clinical conditions. Supplementation of the coenzyme helps guard against a possible deficiency. Aging is considered one reason for a deficiency, since the liver loses its ability to synthesize coenzyme Q10 as one gets older. Besides aging, poor eating habits, stress, and infection affect the body's ability to provide adequate amounts of coenzyme Q10. Known results of using coenzyme Q10 as an oral supplement are energy increase, improvement of heart function, prevention and cure of gum disease, a boost to the immune system, and possible life extension. AIDS is a primary target for research on coenzyme Q10 because of its immense benefits to the immune system. Further, coenzyme Q10 has also been reported to provide a salutary effect in the treatment of breast cancer.

Inositol is necessary for the formation of lecithin and functions closely with choline. Inositol is a fundamental ingredient of cell membranes and is necessary for proper functioning of nerves, brain, and muscles in the body. Inositol functions in conjunction with folacin, vitamin B-6 and vitamin B-12, choline, betaine, and methionine to prevent the accumulation of fats in the liver. Inositol is primarily used in the treatment of liver problems, depression, panic disorder, and diabetes. It is needed for health at the cellular level is concentrated in the lens of the human eye and in the heart. Men taking extra inositol reported that their hair loss decreased, although this has not been tested under clinical situations. Inositol plays an important part in the health of cell membranes especially the specialized cells in the brain, bone marrow, eyes, and intestines. The function of the cell membranes is to regulate the contents of the cells, which makes effective functioning possible. Inositol is said to promote healthy hair, hair growth, and helps in controlling estrogen levels and may assist in preventing breast lumps. It may also be of benefit in reducing blood cholesterol levels. If inositol intake is not sufficient, symptoms such as eczema, hair loss, constipation, abnormalities of the eyes, and elevated cholesterol levels may be experienced. No RDA has been established supplementation is usually 50 mg per day. No toxic effects known, but diarrhea has been noted with the intake of very high dosage of inositol. Inositol is best used with choline, B group vitamins, vitamin E, vitamin C, and linoleic acid.

Methylsulfonylnethane (MSM) is a naturally occurring, organic sulfur-containing compound related to dimethyl sulfoxide(DMSO). Studies have shown that sulfur from oral supplements of MSM is incorporated into body proteins. Other studies have reported that joints affected by osteoarthritis have lower sulfur content, and mice with arthritis given MSM experience less joint deterioration. MSM is a non-metallic organic compound that plays an essential role in human nutrition. When amino acids, zinc, copper, silicon, and vitamin C are present, the body metabolizes MSM to sulfur. Sulfur, a structural component integral to new cell growth, is stored in every cell of the body, particularly the hair, nails, bones, teeth and the connective tissue of joints and skin, where it is an important component of protein. Sulfur also contributes to fat digestion and absorption through its role in bile acid production. As a component of insulin, sulfur is needed to regulate blood sugar.

Spirulina is a microalga that contains 60% all vegetable protein, essential vitamins and phytonutrients, β-carotene, the rare essential fatty acid gamma-linolenic acid (GLA), sulfolipids, glycolipids, and polysaccharides. Research has shown that taking spirulina extracts results in the tumor fighting ability of natural killer cells and gamma-interferon. In another study, spirulina was shown to be a potent inducer of gamma-interferon and a moderate inducer of interleukin-4 and interleukin-1beta. Thus, spirulina strengthens the immune system and promotes immunity to intracellular pathogens and parasites. Other research suggested that spirulina has therapeutic effects on hyperlipidemia and obesity.

Other ingredients may also be added to the formulation. For example, fructose may be added as both an energy source and a sweetener. Fructose does not require insulin to enter certain cells of the body and therefore results in a smooth flow into the bloodstream and from there to the brain and other parts of the body. Low-calorie sweeteners, such as sucralose, may also be used according to the present invention. Flavors may be added to render the formulation more palatable. Synthetic flavors of almost any desired type are now available. Illustrative flavors that can be used according to the present invention include grape, strawberry, pineapple, and lemon flavors. In addition, certain organic acids may be added, such as citric acid, aspartic acid, tartaric acid, and malic acid. Aspartic acid is an amino acid and is used in building muscle. Citric acid is an acidulant, provides a pleasant tart flavor, and a component of effervescent powders. Malic acid is a flavoring agent, flavor enhancer, and acidulant. Tartaric acid is another acidulant and buffering agent.

Illustrative formulations and ranges of these ingredients are:

| | Ranges in Parts by Weight | |
|---|---|---|
| Other Ingredients | Broad | Typical |
| α-Lipoic Acid | 1-25 × 10⁻³ | 1-10 × 10⁻³ |
| Coenzyme Q10 | 1-100 × 10⁻³ | 10-50 × 10⁻³ |
| Inositol | 10-100 × 10⁻³ | 20-80 × 10⁻³ |
| Methylsulfonyl methane | 1-100 × 10⁻³ | 10-50 × 10⁻³ |
| Spirulina | 1-100 × 10⁻³ | 10-50 × 10⁻³ |

Amino Acids

The nutritional value of proteins in the human diet involves recognition of the quality as well as the quantity of the protein. Humans do not have the ability to synthesize all the amino acids required for normal good health. Those that are required to be supplied by the diet are called essential amino acids and include leucine, isoleucine, lysine, methionine, phenylalanine, threonine, tryptophan, and valine. In general, it is recommended that an adult should take in the daily diet 10 g of protein per kg of body weight. Children require about two to three times this amount. Of course, this assumes that the protein in the diet has an adequate amount of all essential and nonessential amino acids. Proteins found in eggs, beef, and milk are considered to have the best nutritional value.

Adequate protein nutrition requires the intake of sufficient protein to meet daily requirements. This protein must be of the necessary quality, i.e., supply the essential amino acids. Protein deficiency thus may be caused by a reduced intake or the use of low-quality protein. Obviously, the actual intake of protein may be influenced by factors such as high excretion in conditions of kidney damage or blood loss, or an increased requirement associated with thyrotoxicosis or high fever. Symptoms of deficiency include loss of weight, nutritional edema, and skin changes and are associated with such conditions as nephrosis, sprue, and colitis. Deficiency may result also in a reduced resistance to infection, since an adequate protein intake is necessary for the formation of phagocytes, leukocytes, and antibodies. Stress, such as brought on by accidental or surgical trauma, pregnancy, and lactation may also cause a deficiency of amino acids, and greater intakes of protein are required in these conditions.

Arginine is useful in enhancing the immune system, and it increases the size and activity of the thymus gland, which is responsible for manufacturing T lymphocytes, which are part of the immune system. Arginine is also important in liver health in that it assists in neutralizing ammonia. It is also involved in the skin and connective tissues, thus it is important in healing and repair of tissues, as well as the formation of collagen and building of new bone and tendons.

Cysteine is critical to the metabolism of a number of essential biochemicals, including coenzyme A, heparin, biotin, lipoic acid, and glutathione. Cysteine, which may be supplied as N-acetylcysteine, helps in strengthening the protective lining of the stomach and intestines. It is a constituent of the antioxidant, glutathione.

Glycine is required for building protein in the body and for synthesis of nucleic acids. Glycine has been found to be useful in aiding the absorption of calcium in the body. It is important for prostate health, and it is used by the nervous system as an inhibitory neurotransmitter, which is important for preventing epileptic seizures and for the treatment of bipolar disorder and hyperactivity.

Histidine is needed for growth and for the repair of tissue, as well as the maintenance of the myelin sheath, which acts as a protector for nerve cells. Histidine is also required for the manufacture of both red and white blood cells, and it helps to protect the body from damage caused by radiation and in removing heavy metals from the body. In the stomach, histidine is also helpful in producing gastric juices.

Isoleucine, together with the other two branched-chain amino acids, promotes muscle recovery after physical exercise. It is also needed for the formation of hemoglobin and for assisting with regulation of blood sugar levels and energy levels. It is also involved in blood clot formation.

Leucine helps with the regulation of blood-sugar levels, the growth and repair of muscle tissue, growth hormone production, wound healing, and energy regulation.

Lysine is required for growth and bone development in children, assists in calcium absorption, and assists in maintaining the correct nitrogen balance in the body and maintaining lean body mass. Further, lysine is needed to produce antibodies, hormones, enzymes, and collagen and to repair tissues.

Methionine assists in the breakdown of fats and thereby prevents the build-up of fat in the arteries. It also assists with proper functioning of the digestive system and for removing heavy metals from the body, since it can be converted to cysteine, a precursor to glutathione, which is of prime importance in detoxifying the liver. Methionine is also a great antioxidant, since the sulfur supplied in methionine inactivates free radicals. Methionine may also be used to treat depression, arthritis pain, and chronic liver disease. It is one of the three amino acids needed by the body to manufacture creatine, a compound essential for energy production and muscle building.

Phenylalanine is used for elevating mood, since it is closely involved with the nervous system. It also helps with memory and learning and has been used as an appetite suppressant.

Threonine is required to help maintain proper protein balance in the body, as well as assisting in formation of collagen and elastin in the skin. It is also involved in liver functioning (including fighting fatty liver), lipotropic functions—along with aspartic acid and methionine, and assisting in the immune system by helping the production of antibodies and promoting thymus growth and activity.

Tryptophan is required for the production of the vitamin, niacin. It is also used by the body to produce serotonin, a neurotransmitter that is important for normal nerve and brain function. Serotonin is important in sleep, stabilizing emotional moods, pain control, fighting inflammation, and maintaining intestinal peristalsis. It is also important in controlling hyperactivity in children, assisting in alleviating stress, helping with weight loss, and reducing appetite.

Valine is needed for and has a stimulating effect on muscle metabolism. It is also needed for repair and growth of tissue and maintaining the nitrogen balance in the body.

Illustrative formulations and ranges of these ingredients are:

| | Ranges in Parts by Weight | |
|---|---|---|
| Amino Acids | Broad | Typical |
| Arginine | 1-500 × 10⁻³ | 10-200 × 10⁻³ |
| Cysteine | 1-250 × 10⁻³ | 10-100 × 10⁻³ |
| Glycine | 1-1,000 × 10⁻³ | 100-800 × 10⁻³ |
| Histidine | 1-500 × 10⁻³ | 10-200 × 10⁻³ |
| Isoleucine | 1-500 × 10⁻³ | 10-200 × 10⁻³ |
| Leucine | 10-500 × 10⁻³ | 50-400 × 10⁻³ |
| Lysine | 1-200 × 10⁻³ | 10-100 × 10⁻³ |
| Methionine | 1-100 × 10⁻³ | 2-50 × 10⁻³ |
| Phenylalanine | 1-100 × 10⁻³ | 10-80 × 10⁻³ |
| Threonine | 1-500 × 10⁻³ | 10-200 × 10⁻³ |
| Tryptophan | 1-200 × 10⁻³ | 2-100 × 10⁻³ |
| Valine | 1-200 × 10⁻³ | 2-100 × 10⁻³ |

### EXAMPLE

The following formulae represent specific embodiments of the invention. These embodiments can be prepared by blending together the stated dry raw materials in an agglomerator to result in a product having a uniform composition with the precise proportions of the components as indicated. The agglomerated material is then illustratively placed in plastic or foil packets, or the like. The formula is then used by opening the packet, placing the powder in a container, adding water or juice to suspend and/or dissolve the powdered ingredients, and then drinking the suspension.

| | Formulation Number | | | | | | | | |
|---|---|---|---|---|---|---|---|---|---|
| Ingredients | I | II | III | IV | V | VI | VII | VIII | IX |
| Xanthones (mg) | 10 | 50 | 25 | 100 | 50 | 20 | 30 | 90 | 5 |
| Vitamin A (IU) | | | 1500 | 1000 | | | 9000 | 5000 | 1600 |
| Vitamin D (IU) | | | 400 | 500 | | | 50 | 800 | 400 |
| Vitamin E (IU) | 200 | 500 | 800 | 750 | 200 | 400 | 150 | 300 | 800 |
| Vitamin K (μg) | | | 80 | 200 | | | 200 | 20 | 80 |
| Vitamin C (mg) | 200 | 1000 | 800 | 2000 | 1000 | 600 | 1800 | 900 | 800 |
| Thiamine (mg) | | | 10 | 40 | | | 5 | 50 | 10 |
| Riboflavin (mg) | | | 8 | 20 | | | 4 | 40 | 8 |
| Niacin (mg) | | | 130 | 30 | | | 150 | 10 | 130 |
| Pyridoxine (mg) | | | 50 | 60 | | | 2 | 80 | 50 |
| Folate (μg) | | | 800 | 1200 | | | 2600 | 200 | 800 |
| Vitamin B-12 (μg) | | | 60 | 100 | | | 150 | 5 | 60 |
| Biotin (μg) | | | 300 | 200 | | | 50 | 1000 | 300 |
| Pantothenic Acid (mg) | | | 15 | 20 | | | 5 | 75 | 15 |
| Choline (mg) | | | 100 | 80 | | | 40 | 200 | 100 |
| Calcium (mg) | 600 | 1500 | 800 | 1200 | 1000 | 600 | 1500 | 1000 | 800 |
| Magnesium (mg) | | | 200 | | 100 | | 50 | 1000 | 200 |
| Chromium (μg) | | | 250 | | 400 | | 25 | 350 | 250 |
| Copper (mg) | 1 | 10 | 2 | 4 | 2 | | 10 | 2 | 2 |
| Iodine (μg) | | | 100 | | 50 | | 200 | 20 | 100 |
| Iron (mg) | 5 | 40 | 20 | 10 | 25 | 30 | 40 | 20 | 20 |
| Manganese (mg) | 2 | 25 | 5 | 10 | 50 | 4 | 2 | 40 | 5 |
| Molybdenum (μg) | | | 30 | | 40 | | 5 | 100 | 30 |
| Selenium (μg) | 100 | 500 | 250 | 200 | 50 | 300 | 50 | 800 | 250 |
| Zinc (mg) | 10 | 80 | 20 | 40 | 100 | 15 | 100 | 10 | 20 |
| Boron (μg) | | | 500 | | 100 | | 800 | 300 | 500 |
| Potassium (mg) | | | 250 | | 100 | | 50 | 450 | 250 |
| Sodium (mg) | | | 250 | | 100 | | 100 | 300 | 250 |
| Silicon (mg) | | | 20 | | 25 | | 10 | 100 | |
| Methylsulfonyl | | | 25 | | | 50 | 10 | 50 | 25 |
| methane (mg) | | | | | | | | | |
| β-Carotene (mg) | 50 | 150 | 100 | 200 | 80 | 100 | 10 | 160 | |
| Lutein (μg) | 100 | 800 | 200 | 200 | 500 | 150 | 100 | 1000 | 200 |
| Lycopene (μg) | 100 | 800 | 200 | 200 | 300 | 100 | 100 | 1000 | 200 |
| PABA (mg) | | | 50 | 100 | | | 10 | 1000 | 50 |
| Inositol (mg) | | | 50 | | | 100 | 100 | 30 | 50 |
| Spirulina (mg) | | | 25 | | | 50 | 100 | 10 | 25 |
| Grape Seed | 8 | 50 | 10 | 40 | 10 | 5 | 80 | 20 | 10 |
| Extract (mg) | | | | | | | | | |
| Quercetin (mg) | 20 | 75 | 25 | 60 | 60 | 10 | 5 | 80 | 25 |
| α-Lipoic Acid (mg) | 3 | 20 | 5 | 10 | 2 | 5 | 1 | 25 | 5 |
| Coenzyme Q10 (mg) | | | 30 | | | 20 | 10 | 90 | 30 |
| Cysteine (mg) | | | 50 | | | | 10 | 200 | 50 |
| Arginine (mg) | | | 100 | | | | 200 | 20 | 100 |
| Glycine (mg) | | | 500 | | | | 10 | 1000 | 500 |
| Histidine (mg) | | | 100 | | | | 10 | 400 | 100 |
| Isoleucine (mg) | | | 100 | | | | 200 | 400 | 100 |
| Leucine (mg) | | | 200 | | | | 200 | 400 | 200 |
| Lysine (mg) | | | 50 | | | | 200 | 10 | 50 |
| Methionine (mg) | 5 | 50 | 10 | 10 | 8 | 40 | 2 | 100 | 10 |
| Phenylalanine (mg) | | | 50 | | | | 10 | 40 | 50 |
| Threonine (mg) | | | 100 | | | | 100 | 500 | 100 |
| Tryptophan (mg) | | | 50 | | | | 200 | 50 | 50 |
| Valine (mg) | | | 50 | | | | 200 | 10 | 50 |

1. A nutritional supplement composition consisting essentially of a mixture of one or more organic-solvent-extracted xanthones and one or more vitamins selected from the group consisting of vitamin A, vitamin C, vitamin D, vitamin E, vitamin K, vitamin B-12, thiamine, riboflavin, niacin, pantothenic acid, pyridoxine, folic acid, biotin, derivatives thereof, and mixtures thereof.

2. The nutritional supplement composition of claim 1 further comprising one or more minerals selected from the group consisting of calcium, magnesium, chromium, copper, iodine, iron, manganese, molybdenum, selenium, zinc, boron, sodium, potassium, silicon, and mixtures thereof.

3. The nutritional supplement composition of claim 1 further comprising one or more carotenoids selected from the group consisting of 1-carotene, lutein, lycopene, and mixtures thereof.

4. The nutritional supplement composition of claim 1 further comprising one or more bioflavonoids selected from the group consisting of grape seed extract, quercetin, and mixtures thereof.

5. The nutritional supplement composition of claim 1 further comprising one or more nutrients selected from the group consisting of choline, para-aminobenzoic acid, alpha-lipoic acid, coenzyme Q10, inositol, methylsulfonyl methane, spirulina, and mixtures thereof.

6. The nutritional supplement composition of claim 1 further comprising one or more amino acids selected from the group consisting of arginine, cysteine, glycine, histidine, isoleucine, leucine, methionine, phenylalanine, threonine, tryptophan, valine, and mixtures thereof.

7. The nutritional supplement composition of claim 1 wherein the nutritional supplement composition is in liquid form.

8. The nutritional supplement composition of claim 1 wherein the nutritional supplement composition is in powdered, capsule, or tablet form.

9. A nutritional supplement composition consisting essentially of a mixture of one or more organic-solvent-extracted xanthones and one or more minerals selected from the group consisting of calcium, magnesium, chromium, copper, iodine, iron, manganese, molybdenum, selenium, zinc, boron, sodium, potassium, silicon, and mixtures thereof.

10. The nutritional supplement composition of claim 9 further comprising one or more carotenoids selected from the group consisting of β-carotene, lutein, lycopene, and mixtures thereof.

11. The nutritional supplement composition of claim 9 further comprising one or more bioflavonoids selected from the group consisting of grape seed extract, quercetin, and mixtures thereof.

12. The nutritional supplement composition of claim 9 further comprising one or more nutrients selected from the group consisting of choline, para-aminobenzoic acid, alpha-lipoic acid, coenzyme Q10, inositol, methylsulfonyl methane, spirulina, and mixtures thereof.

13. The nutritional supplement composition of claim 9 further comprising one or more amino acids selected from the group consisting of arginine, cysteine, glycine, histidine, isoleucine, leucine, methionine, phenylalanine, threonine, tryptophan, valine, and mixtures thereof.

14. The nutritional supplement composition of claim 13 further comprising one or more vitamins selected from the group consisting of vitamin A, vitamin C, vitamin D, vitamin E, vitamin K, vitamin B-12, thiamine, riboflavin, niacin, pantothenic acid, pyridoxine, folic acid, biotin, derivatives thereof, and mixtures thereof.

15. The nutritional supplement composition of claim 9 wherein the nutritional supplement composition is in liquid form.

16. The nutritional supplement composition of claim 9 wherein the nutritional supplement composition is in powdered, capsule, or tablet form.

17. A nutritional supplement composition comprising a mixture of about 1-200×10⁻³ parts by weight of one or more organic-solvent-extracted xanthones, about 100-3,000×10⁻³ parts by weight of vitamin C, about 10-800 international units of vitamin E, about 500-2,000×10⁻³ parts by weight of calcium, about 1-10×10⁻³ parts by weight of copper, about 1-40×10⁻³ parts by weight of iron, about 1-50×10⁻³ parts by weight of manganese, about 2-100×10⁻³ parts by weight of zinc, about 20-1,000×10⁻⁶ parts by weight of selenium, about 1-200×10⁻³ parts by weight of β-carotene, about 10-1,000×10⁻⁶ parts by weight of lutein, about 10-1,000×10⁻⁶ parts by weight of lycopene, about 5-100×10⁻³ parts by weight of quercetin, about 1-100×10⁻³ parts by weight of grape seed extract, about 1-25×10⁻³ parts by weight of α-lipoic acid, and about 1-100×10⁻³ parts by weight of methionine.

18. The nutritional supplement composition of claim 17 wherein the one or more organic-solvent-extracted xanthones are extracted from a plant selected from the group consisting of Garcinia mangostana, Kielmeyera variabilis, Swertia davidi, and mixtures thereof.

19. The nutritional supplement composition of claim 17 further comprising about 1,000-10,000 international units of vitamin A, about 50-1,000 international units of vitamin D, about 20-200×10⁻⁶ parts by weight of vitamin K, about 1-50×10⁻³ parts by weight of thiamine, about 1-40×10⁻³ parts by weight of riboflavin, about 0.5-150×10⁻³ parts by weight of niacin or niacinamide or a mixture thereof, 1-100×10⁻³ parts by weight of pantothenic acid, about 1-100×10⁻³ parts by weight of pyridoxine, about 100-3,000×10⁻⁶ parts by weight of folic acid, about 2-160×10⁻⁶ parts by weight of vitamin B-12, about 50-5,000×10⁻⁶ parts by weight of biotin, about 25-600×10⁻³ parts by weight of choline, and about 1-100×10⁻³ parts by weight of para-aminobenzoic acid.

20. The nutritional supplement composition of claim 17 further comprising about 50-1,000×10⁻³ parts by weight of magnesium, about 10-500×10⁻⁶ parts by weight of chromium, about 10-500×10⁻⁶ parts by weight of iodine, about 5-200×10⁻⁶ parts by weight of molybdenum, 100-1,000×10⁻⁶ parts by weight of boron, about 100-500×10⁻³ parts by weight of sodium, about 10-500×10⁻³ parts by weight of potassium, and about 1-100×10⁻³ parts by weight of silicon.

21. The nutritional supplement composition of claim 17 further comprising about 1-100×10⁻³ parts by weight of coenzyme Q10, about 10-100×10⁻³ parts by weight of inositol, about 1-100×10⁻³ parts by weight of methylsulfonyl methane, and about 1-100×10⁻³ parts by weight of Spirulina.

22. The nutritional supplement composition of claim 17 further comprising about 10-500×10⁻³ parts by weight of leucine, about 1-500×10⁻³ parts by weight of isoleucine, about 1-200×10⁻³ parts by weight of lysine, about 1-100×10⁻³ parts by weight of phenylalanine, about 1-500×10⁻³ parts by weight of threonine, about 1-200×10⁻³ parts by weight of tryptophan, and about 1-200×10⁻³ parts by weight of valine.

23. The nutritional supplement composition of claim 22 further comprising about 1-500×10⁻³ parts by weight of arginine, about 1-250×10⁻³ parts by weight of cysteine, about 1-1,000×10⁻³ parts by weight of glycine, and about 1-500×10⁻³ parts by weight of histidine.

24. The nutritional supplement composition of claim 17 wherein the nutritional supplement composition is in liquid form.

25. The nutritional supplement composition of claim 17 wherein the nutritional supplement composition is in powdered, capsule, or tablet form.

26. A nutritional supplement composition comprising a mixture of about 1-200×10⁻³ parts by weight of one or more extracted xanthones, about 100-3,000×10⁻³ parts by weight of vitamin C, about 10-800 international units of vitamin E, about 1,000-10,000 international units of vitamin A, about 50-1,000 international units of vitamin D, about 20-200×10⁻⁶ parts by weight of vitamin K, about 1-50×10⁻³ parts by weight of thiamine, about 1-40×10⁻³ parts by weight of riboflavin, about 0.5-150×10⁻³ parts by weight of niacin or niacinamide or a mixture thereof, 1-100×10⁻³ parts by weight of pantothenic acid, about 1-100×10⁻³ parts by weight of pyridoxine, about 100-3,000×10⁻⁶ parts by weight of folic acid, about 2-160×10⁻⁶ parts by weight of vitamin B-12, about 50-5,000×10⁻⁶ parts by weight of biotin, about 25-600×10⁻³ parts by weight of choline, about 1-100×10⁻³ parts by weight of para-aminobenzoic acid, about 500-2,000×10⁻³ parts by weight of calcium, about 1-10×10⁻³ parts by weight of copper, about 1-40×10⁻³ parts by weight of iron, about 1-50×10⁻³ parts by weight of manganese, about 2-100×10⁻³ parts by weight of zinc, about 20-1,000×10⁻⁶ parts by weight of selenium, about 50-1,000×10⁻³ parts by weight of magnesium, about 10-500×10⁻⁶ parts by weight of chromium, about 10-500×10⁻⁶ parts by weight of iodine, about 5-200×10⁻⁶ parts by weight of molybdenum, 100-1,000×10⁻⁶ parts by weight of boron, about 100-500×10⁻³ parts by weight of sodium, about 10-500×10⁻³ parts by weight of potassium, about 1-100×10⁻³ parts by weight of silicon, about 1-200×10⁻³ parts by weight of β-carotene, about 10-1,000×10⁻⁶ parts by weight of lutein, about 10-1,000×10⁻⁶ parts by weight of lycopene, about 5-100×10⁻³ parts by weight of quercetin, about 1-100×10⁻³ parts by weight of grape seed extract, about 1-25×10⁻³ parts by weight of α-lipoic acid, about 1-100×10⁻³ parts by weight of coenzyme Q10, about 10-100×10⁻³ parts by weight of inositol, about 1-100×10⁻³ parts by weight of methylsulfonyl methane, about 1-100×10⁻³ parts by weight of Spirulina, about 1-100×10⁻³ parts by weight of methionine, about 10-500×10⁻³ parts by weight of leucine, about 1-500×10⁻³ parts by weight of isoleucine, about 1-200×10⁻³ parts by weight of lysine, about 1-100×10⁻³ parts by weight of phenylalanine, about 1-500×10⁻³ parts by weight of threonine, about 1-200×10⁻³ parts by weight of tryptophan, about 1-200×10⁻³ parts by weight of valine, about 1-500×10⁻³ parts by weight of arginine, about 1-250×10⁻³ parts by weight of cysteine, about 1-1,000×10⁻³ parts by weight of glycine, and about 1-500×10⁻³ parts by weight of histidine.

27. The nutritional supplement composition of claim 26 wherein the nutritional supplement composition is in liquid form.

28. The nutritional supplement composition of claim 26 wherein the nutritional supplement composition is in powdered, capsule, or tablet form.

29. A nutritional supplement composition consisting essentially of a mixture of one or more organic-solvent-extracted xanthones and
(a) one or more vitamins selected from the group consisting of vitamin A, vitamin C, vitamin D, vitamin E, vitamin K, vitamin B-12, thiamine, riboflavin, niacin, pantothenic acid, pyridoxine, folic acid, biotin, derivatives thereof, and mixtures thereof; or
(b) one or more minerals selected from the group consisting of calcium, magnesium, chromium, copper, iodine, iron, manganese, molybdenum, selenium, zinc, boron, sodium, potassium, silicon, and mixtures thereof; or
(c) one or more carotenoids selected from the group consisting of β-carotene, lutein, lycopene, and mixtures thereof; or
(d) one or more bioflavonoids selected from the group consisting of grape seed extract, quercetin, and mixtures thereof; or
(e) one or more nutrients selected from the group consisting of choline, para-aminobenzoic acid, alpha-lipoic acid, coenzyme Q10, inositol, methylsulfonyl methane, spirulina, and mixtures thereof; or
(f) one or more amino acids selected from the group consisting of arginine, cysteine, glycine, histidine, isoleucine, leucine, methionine, phenylalanine, threonine, tryptophan, valine, and mixtures thereof.

30. A method for supplementing the diet of an individual, the method comprising orally administering to the individual a nutritional supplement composition comprising a mixture of about 1-200×10⁻³ parts by weight of one or more extracted xanthones, about 100-3,000×10⁻³ parts by weight of vitamin C, about 10-800 international units of vitamin E, about 500-2,000×10⁻³ parts by weight of calcium, about 1-10×10⁻³ parts by weight of copper, about 1-40×10⁻³ parts by weight of iron, about 1-50×10⁻³ parts by weight of manganese, about 2-100×10⁻³ parts by weight of zinc, about 20-1,000×10⁻⁶ parts by weight of selenium, about 1-200×10⁻³ parts by weight of 5-carotene, about 10-1,000×10⁻⁶ parts by weight of lutein, about 10-1,000×10⁻⁶ parts by weight of lycopene, about 5-100×10⁻³ parts by weight of quercetin, about 1-100×10⁻³ parts by weight of grape seed extract, about 1-25×10⁻³ parts by weight of α-lipoic acid, and about 1-100×10⁻³ parts by weight of methionine.

31. The method of claim 30 wherein the nutritional supplement composition further comprises about 1,000-10,000 international units of vitamin A, about 50-1,000 international units of vitamin D, about 20-200×10⁻⁶ parts by weight of vitamin K, about 1-50×10⁻³ parts by weight of thiamine, about 1-40×10⁻³ parts by weight of riboflavin, about 0.5-150×10⁻³ parts by weight of niacin or niacinamide or a mixture thereof, 1-100×10⁻³ parts by weight of pantothenic acid, about 1-100×10⁻³ parts by weight of pyridoxine, about 100-3,000×10⁻⁶ parts by weight of folic acid, about 2-160×10⁻⁶ parts by weight of vitamin B-12, about 50-5,000×10⁻⁶ parts by weight of biotin, about 25-600×10⁻³ parts by weight of choline, and about 1-100×10⁻³ parts by weight of para-aminobenzoic acid.

32. The method of claim 30 wherein the nutritional supplement composition further comprises about 50-1,000×10⁻³ parts by weight of magnesium, about 10-500×10⁻⁶ parts by weight of chromium, about 10-500×10⁻⁶ parts by weight of iodine, about 5-200×10⁻⁶ parts by weight of molybdenum, 100-1,000×10⁻⁶ parts by weight of boron, about 100-500×10⁻³ parts by weight of sodium, about 10-500×10⁻³ parts by weight of potassium, and about 1-100×10⁻³ parts by weight of silicon.

33. The method of claim 30 wherein the nutritional supplement composition further comprises about 1-100×10⁻³ parts by weight of coenzyme Q10, about 10-100×10⁻³ parts by weight of inositol, about 1-100×10⁻³ parts by weight of methylsulfonyl methane, and about 1-100×10⁻³ parts by weight of Spirulina.

34. The method of claim 30 wherein the nutritional supplement composition further comprises about 10-500×10⁻³ parts by weight of leucine, about 1-500×10⁻³ parts by weight of isoleucine, about 1-200×10⁻³ parts by weight of lysine, about 1-100×10⁻³ parts by weight of phenylalanine, about 1-500×10⁻³ parts by weight of threonine, about 1-200×10⁻³ parts by weight of tryptophan, and about 1-200×10⁻³ parts by weight of valine.

35. The method of claim 34 wherein the nutritional supplement composition further comprises about 1-500×10⁻³ parts by weight of arginine, about 1-250×10⁻³ parts by weight of cysteine, about 1-1,000×10⁻³ parts by weight of glycine, and about 1-500×10⁻³ parts by weight of histidine.

36. The method of claim 30 wherein the nutritional supplement composition is in liquid form.

37. The method of claim 30 wherein the nutritional supplement composition is in powdered, capsule, or tablet form.

38. A nutritional supplement composition consisting essentially of a mixture of one or more organic-solvent-extracted xanthones and a nutrient.
